(19) United States
(12) Patent Application Publication
(10) Pub. No.: US 2011/0095994 A1
(43) Pub. Date: Apr. 28, 2011

(54) Systems And Methods For Using Static Surface Features On A Touch-Screen For Tactile Feedback

(75) Inventor: David Birnbaum, Oakland, CA (US)

(73) Assignee: Immersion Corporation, San Jose, CA (US)

(21) Appl. No.: 12/605,651

(22) Filed: Oct. 26, 2009

(51) Int. Cl. G06F 3/041

(52) U.S. Cl. 345/173; 116/205

(57) ABSTRACT

Systems and methods for using static surface features on a touch-screen for tactile feedback are disclosed. For example, one disclosed system includes a processor configured to transmit a display signal, the display signal comprising a plurality of display elements; and a display configured to output a visual representation of the display signal, the display including: touch-sensitive input device; and one or more static surface features covering at least a portion of the display.

### FIELD OF THE INVENTION

The present invention generally relates to messaging systems, and more specifically to systems and methods for using static surface features on a touch-screen for tactile feedback.

### BACKGROUND

The use of touch-screens in all types of devices is becoming more common. Conventional touch-screens have a smooth surface, but many touch-screens could benefit from tactile feedback. Accordingly, there is a need for systems and methods for using static surface features on a touch-screen for tactile feedback.

### SUMMARY

Embodiments of the present invention provide systems and methods for using static surface features on a touch-screen for tactile feedback. For example, in one embodiment a system for using static surface features on a touch-screen for tactile feedback comprises: a processor configured to transmit a display signal, the display signal comprising a plurality of display elements; and a display configured to output a visual representation of the display signal, the display comprising: a touch-sensitive input device; and one or more static surface features covering at least a portion of the display.

These illustrative embodiments are mentioned not to limit or define the invention, but to provide examples to aid understanding thereof. Illustrative embodiments are discussed in the Detailed Description along with a further description of the invention. Advantages offered by various embodiments of this invention may be further understood by examining this specification.

### BRIEF DESCRIPTION OF THE DRAWINGS

The features, aspects, and advantages of the present invention are better understood when the following Detailed Description is read in conjunction with the accompanying figures, wherein:

FIG. 1 is a block diagram of a system for using static surface features on a touch-screen for tactile feedback according to one embodiment of the present invention;

FIG. 2 is an illustrative embodiment of a system for using static surface features on a touch-screen for tactile feedback according to one embodiment of the present invention;

FIG. 3 is a flow diagram illustrating a method for using static surface features on a touch-screen for tactile feedback according to one embodiment of the present invention;

FIGS. 4a and 4b are cross-section illustrations of a system for using static surface features on a touch-screen for tactile feedback according to one embodiment of the present invention;

FIGS. 5a, 5b, and 5c are illustrations of a system for using static surface features on a touch-screen for tactile feedback according to one embodiment of the present invention; and

FIGS. 6a, 6b, 6c, and 6d are illustrations of a system for using static surface features on a touch-screen for tactile feedback according to one embodiment of the present invention.

### DETAILED DESCRIPTION

Embodiments of the present invention provide systems and methods for using static surface features on a touch-screen for tactile feedback.

### Illustrative Embodiment of Using Static Surface Features on a Touch-Screen for Tactile Feedback

One illustrative embodiment of the present invention comprises a mobile device such as a mobile phone. The mobile device comprises a housing, which contains a touch-screen display. The mobile device also comprises a processor and memory. The processor is in communication with both the memory and the touch-screen display. To provide active haptic feedback, the illustrative mobile device comprises an actuator, which is in communication with the processor. The actuator is configured to receive a haptic signal from the processor, and in response, output a haptic effect. In the illustrative embodiment, as the user interacts with the mobile device, the processor generates the appropriate haptic signal and transmits the signal to the actuator. The actuator then produces the appropriate haptic effect.

In the illustrative embodiment, the touch-screen display is configured to receive signals from the processor and display a graphical user interface. The touch-screen of the illustrative device also comprises static surface features, which provide tactile feedback. In the illustrative embodiment, raised or lowered sections of the touch-screen create the static surface features. These raised or lowered sections form ridges and troughs that the user will feel when interacting with the touch-screen. In some embodiments, these ridges and troughs may form a pattern that the user will recognize. For example, in the illustrative device, the touch-screen comprises static surface features that form the letters and numbers of a QWERTY keyboard. In some embodiments, the graphical user interface displayed by the touch-screen comprises a keyboard corresponding to the static surface features on the surface of the touch-screen. For example, the static surface features on a touch-screen display may form a QWERTY keyboard, while a corresponding virtual QWERTY keyboard is shown on the display. In other embodiments, the image shown on the display does not correspond to the static surface features. For example, the static surface features may form a QWERTY keyboard, while the display shows a user defined background image.

The addition of static surface features to an ordinarily flat touch-screen increases the usability of the mobile device. Static surface features provide users with one or more fixed reference points. These reference points provide users with a simple means for determining their finger's location on the touch-screen, without looking at the touch-screen. Thus, the user can focus on other activities while still effectively using the mobile device.

This illustrative example is given to introduce the reader to the general subject matter discussed herein. The invention is not limited to this example. The following sections describe various additional embodiments and examples of methods and systems for using static surface features on a touch-screen for tactile feedback.

### Illustrative Systems for Using Static Surface Features on a Touch-Screen for Tactile Feedback

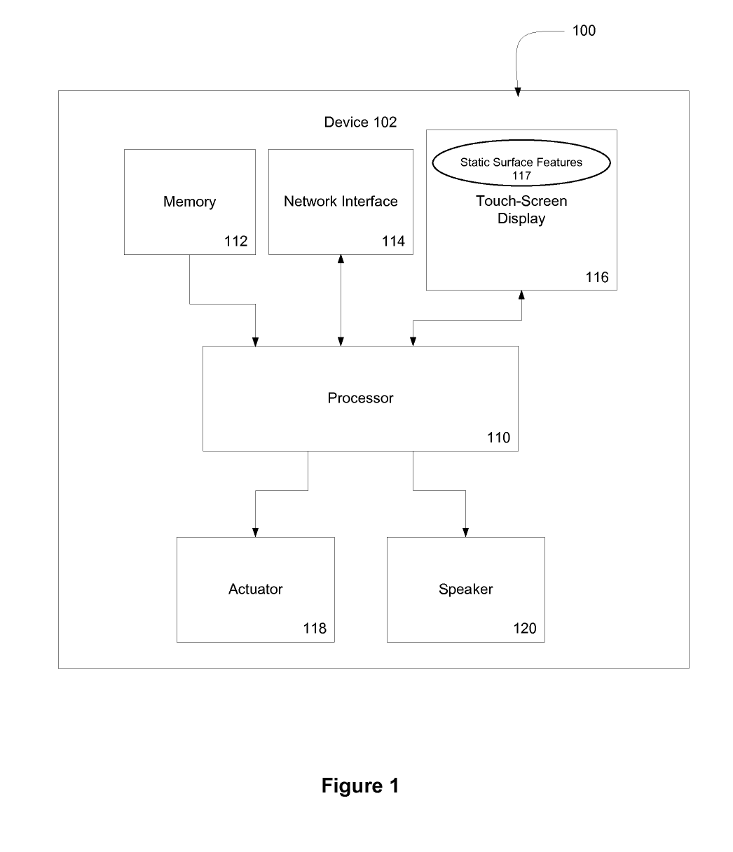

Referring now to the drawings in which like numerals indicate like elements throughout the several Figures, FIG. 1 is a block diagram of a system for using static surface features on a touch-screen for tactile feedback according to one embodiment of the present invention. As shown in FIG. 1, the system 100 comprises a mobile device 102, such as a mobile phone, portable digital assistant (PDA), portable media player, or portable gaming device. The mobile device 102 comprises a processor 110. The processor 110 includes or is in communication with one or more computer-readable media, such as memory 112, which may comprise random access memory (RAM). Processor 110 is in communication with a network interface 114, a touch-screen display 116 comprising static surface features 117, an actuator 118, and a speaker 120. The processor 110 is configured to generate a graphical user interface, which is displayed to the user via touch-screen display 116.

Embodiments of the present invention can be implemented in combination with, or may comprise combinations of, digital electronic circuitry, computer hardware, firmware, and software. The mobile device 102 shown in FIG. 1 comprises a processor 110, which receives input signals and generates signals for communication, display, and providing haptic feedback. The processor 110 also includes or is in communication with one or more computer-readable media, such as memory 112, which may comprise random access memory (RAM).

The processor 110 is configured to execute computer-executable program instructions stored in memory 112. For example, processor 110 may execute one or more computer programs for messaging or for generating haptic feedback. Processor 110 may comprise a microprocessor, a digital signal processor (DSP), an application-specific integrated circuit (ASIC), one or more field programmable gate arrays (FPGAs), or state machines. Processor 110 may further comprise a programmable electronic device such as a programmable logic controller (PLC), a programmable interrupt controller (PIC), a programmable logic device (PLD), a programmable read-only memory (PROM), an electronically programmable read-only memory (EPROM or EEPROM), or other similar devices.

Memory 112 comprises a computer-readable medium that stores instructions, which when executed by processor 110, causes processor 110 to perform various steps, such as those described herein. Embodiments of computer-readable media may comprise, but are not limited to, an electronic, optical, magnetic, or other storage or transmission devices capable of providing processor 110 with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. In addition, various other devices may include computer-readable media such as a router, private or public network, or other transmission devices. The processor 110 and the processing described may be in one or more structures, and may be dispersed throughout one or more structures.

Processor 110 is in communication with a network interface 114. Network interface 114 may comprise one or more methods of mobile communication, such as infrared, radio, Wi-Fi or cellular network communication. In other variations, network interface 114 comprises a wired network interface, such as Ethernet. The mobile device 102 is configured to exchange data with other devices (not shown in FIG. 1) over networks such as a cellular network and/or the Internet. Embodiments of data exchanged between devices may comprise voice messages, text messages, data messages, or other forms of messages.

In the embodiment shown in FIG. 1, the processor 110 is also in communication with a touch-screen display 116. Touch-screen display 116 is configured to display output from the processor 110 to the user. For instance, in one embodiment, mobile device 102 comprises a liquid crystal display (LCD) disposed beneath a touch-screen. In some embodiments, the display and the touch-screen comprise a single, integrated component such as a touch-screen LCD. The processor 110 is configured to generate a signal, which is associated with a graphical representation of a user interface shown on touch-screen display 116.

Touch-screen display 116 is configured to detect a user interaction and transmit signals corresponding to that user interaction to processor 110. Processor 110 then uses the received signals to modify the graphical user interface displayed on touch-screen display 116. Thus, a user may interact with virtual objects displayed on touch-screen display 116. For example, touch-screen display 116 may comprise a virtual keyboard. When the user interacts with the keys of the virtual keyboard, touch-screen display 116 transmits signals corresponding to that interaction to processor 110. Based on the received signals, processor 110 may determine that the user has depressed certain keys on the virtual keyboard. This functionality may be used to, for example, enter a text message or other text document. In other embodiments, touch-screen display 116 may enable the user to interact with other virtual objects such as stereo controls, map functions, virtual message objects, or other types of graphical user interfaces. Thus, touch-screen display 116 gives users the ability to interact directly with the contents of the graphical user interface it displays.

In some embodiments, in addition to touch-screen display 116, mobile device 102 may comprise additional forms of input, such as a track ball, buttons, keys, a scroll wheel, and/or a joystick (not shown in FIG. 1). These additional forms of input may be used to interact with the graphical user interface displayed on touch-screen display 116.

Touch-screen display 116 comprises static surface features 117 covering at least a portion of its surface. Static surface features 117 are formed by raising or lowering sections of the surface of touch-screen display 116. These raised or lowered portions form ridges and troughs that the user will feel when interacting with touch-screen display 116. The ridges and troughs may form shapes that the user recognizes. For example, in one embodiment, the static surface features may take the form of letters and numbers arranged in a QWERTY keyboard configuration. In other embodiments, the static surface features may form other shapes, for example, a grid or a swirl.

In some embodiments, static surface features 117 may be permanently applied to the surface of touch-screen display 116. In other embodiments, the user applies a removable skin to the surface of touch-screen display 116, the removable skin comprising static surface features 117. In such an embodiment, the user may remove the skin and replace it with a different skin comprising different static surface features. Thus, the user may apply different static surface features for different applications. Mobile device 102 may further comprise a data store, which comprises data regarding the location of static surface features 117 on touch-screen display 116. In some embodiments, the data store is a portion of memory 122. Processor 110 may use the information in the data store to modify the graphical user interface displayed on touch-screen display 116. For example, processor 110 may display a virtual keyboard corresponding to a skin comprising static surface features in the form of a keyboard.

When the user applies a new skin with different static surface features 117, the user may update the data store to reflect the change in the static surface features 117. In one embodiment, the user may update the data-store manually using one the inputs of mobile device 102. In other embodiments, processor 110 may use network interface 114 to download information about the static surface features. In still other embodiments, mobile device 102 may comprise a sensor, which detects when the user applies a new skin to the surface of touch-screen display 116. In such an embodiment, the skin comprises a unique identifier that matches its static surface features. For example, a skin may comprise static surface features in the form of a QWERTY keyboard, and further comprise a unique identifier corresponding to a QWERTY keyboard. When the user places the skin over the surface of touch-screen display 116, a sensor detects the unique identifier, and transmits a signal corresponding to that unique identifier to processor 110. The unique identifier may be for example, a magnetic identifier, a bar code, an RFID tag, or another sensor readable identifier. In other embodiments, the unique identifier may be a number, which the user reads and then manually enters into the mobile device.

Once processor 110 receives a signal corresponding to the skin's unique identifier, processor 110 may access the data store to determine the appropriate action to take when it detects a new skin. For example, when processor 110 receives an indication that the user placed a skin comprising static surface features in the form of a QWERTY keyboard over touch-screen display 116, processor 110 may determine to display a virtual QWERTY keyboard on touch-screen display 116. This embodiment enables a user to have multiple skins comprising different static surface features, for use with different applications. For example, in one embodiment, a user may apply a skin comprising static surface features that form a QWERTY keyboard, for use when entering a text message. In another embodiment, the user may apply a skin comprising static surface features in the form of stereo controls for use with a music player application. In another embodiment, the user may apply a skin comprising static surface features in the form of numbers and mathematical symbols for use with the mobile device's calculator function.

In some embodiments, touch-screen display 116 may display a graphical user interface that corresponds to static surface features 117. For example, in one embodiment, static surface features 117 may form a QWERTY keyboard. In this embodiment, at certain times, touch-screen display 116 may display a virtual QWERTY keyboard that corresponds to static surface features 117. In other embodiments, touch-screen display 116 may also show an image that does not correspond to static surface features 117. For example, touch-screen display 116 may comprise static surface features 117 in the form of a keyboard, while display 116 displays a user defined background image. During the display of such images, the static surface features do not add to the usability of the device.

As shown in FIG. 1, processor 110 is also in communication with one or more actuators 118. Processor 110 is configured to determine a haptic effect, and transmit a corresponding haptic signal to actuator 118. Actuator 118 is configured to receive the haptic signal from the processor 110 and generate a haptic effect. Actuator 118 may be, for example, a piezoelectric actuator, an electric motor, an electro-magnetic actuator, a voice coil, a linear resonant actuator, a shape memory alloy, an electro-active polymer, a solenoid, an eccentric rotating mass motor (ERM), or a linear resonant actuator (LRA).

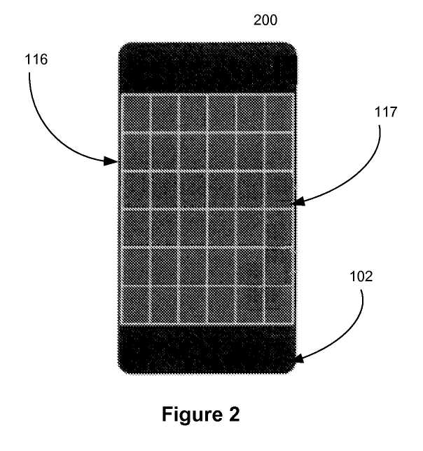

FIG. 2 is an illustrative embodiment of a system for using static surface features on a touch-screen for tactile feedback according to one embodiment of the present invention. The elements of system 200 are described with reference to the system depicted in FIG. 1, but a variety of other implementations are possible.

As shown in FIG. 2, system 200 comprises a mobile device 102, such as a mobile phone, portable digital assistant (PDA), portable media player, or portable gaming device. Mobile device 102 may include a wireless network interface and/or a wired network interface 114 (not shown in FIG. 2). Mobile device 102 may use this network interface to send and receive signals comprising voice-mail, text messages, and other data messages over a network such as a cellular network, intranet, or the Internet. Although FIG. 2 illustrates device 102 as a handheld mobile device, other embodiments may use other devices, such as video game systems and/or personal computers.

As shown in FIG. 2, mobile device 102 comprises a touch-screen display 116. In addition to touch-screen display 116, the mobile device 102 may comprise buttons, a

Touch-screen display 116 is further configured to detect user interaction and transmit signals corresponding to that interaction to processor 110. Processor 110 may then manipulate the image displayed on touch-screen display 116 in a way that corresponds to the user interaction. Thus, a user may interact with virtual objects displayed on touch-screen display 116. For example, touch-screen display 116 may comprise a virtual keyboard. Then, when the user interacts with the keys of the virtual keyboard, touch-screen display 116 transmits signals corresponding to that interaction to processor 110. Based on this signal, processor 110 will determine that the user has depressed certain keys on the virtual keyboard. A user may use such an embodiment, for example, to enter a text message or other text document. In other embodiments, touch-screen display 116 may enable the user to interact with other virtual objects such as stereo controls, map functions, virtual message objects, or other types of virtual user interfaces.

Touch-screen display 116 comprises static surface features 117. These static surface features are formed by raising or lowering sections of touch-screen display 116. These raised or lowered sections form troughs and ridges that the user can feel on the ordinarily flat surface of touch-screen display 116. In the embodiment shown in FIG. 2, static surface features 117 form a grid overlaying touch-screen display 116. In other embodiments, the static surface features may form a QWERTY keyboard, stereo controls, the numbers and symbols of a calculator, or some other pattern.

In some embodiments, the troughs and ridges may be formed at the time touch-screen display 116 is manufactured. In such an embodiment, static surface features 117 are permanent. In other embodiments, the user installs a skin comprising troughs or ridges over the surface of touch-screen display 116. In such an embodiment, the user may change the static surface features on touch-screen display 116 by changing the skin. Thus, the user may have multiple skins comprising different static surface features for different applications. For example, a user may apply a skin comprising static surface features that form a QWERTY keyboard for a text messaging application. Then, when the user wishes to use the mobile device as a portable music player, the user may apply a skin comprising static surface features in the form of stereo controls.

### Illustrative Methods for Using Static Surface Features on a Touch-Screen for Tactile Feedback

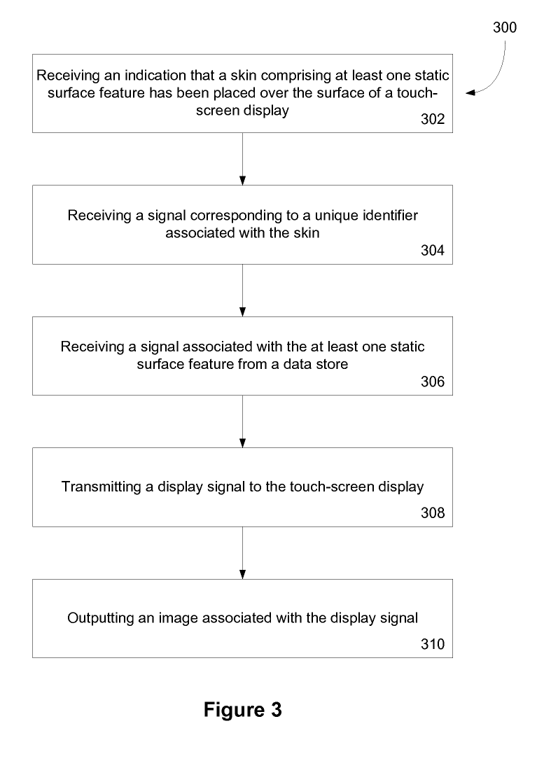

FIG. 3 is a flow diagram illustrating a method for using static surface features on a touch-screen for tactile feedback according to one embodiment of the present invention.

The method 300 begins when processor 110 receives an indication that a skin comprising at least one static surface feature 117 has been placed over the surface of touch-screen display 116, 302. In some embodiments, the processor 110 receives indication from touch-screen display 116. For example, touch-screen display 116 may detect the skin and transmit a corresponding signal to processor 110. In another example, the user may enter the indication via touch-screen display 116. In other embodiments, the mobile device may comprise another sensor, which detects that the user placed a skin over the surface of touch-screen display 116. This sensor may be, for example, one or more of a bar code reader, a camera sensor, an RFID reader, an electromagnetic reader, or some other sensor.

The static surface features may form shapes, which the user may recognize. For example, in one embodiment, the static surface features may take the form of letters and numbers organized in a QWERTY keyboard configuration. In other embodiments, the static surface features may form a grid, swirl, or some other pattern. The skin comprising static surface features is interchangeable, thus the user has the option of placing different surface features on the surface of the touch-screen display 116 for different applications.

Next, processor 110 receives a signal corresponding to a unique identifier associated with the skin 304. In some embodiments, the unique identifier may be a number on the skin. In such an embodiment, the user may manually enter the number via touch-screen display 116, which transmits a signal associated with the unique identifier to processor 110. In other embodiments, the mobile device may comprise a sensor, which detects the unique identifier associated with the skin. For example, in one embodiment the skin may comprise a bar code, an RFID, or a magnetic ID. In such an embodiment, the mobile device comprises a sensor, which detects the unique identifier and transmits a corresponding signal to processor 110. In other embodiments, touch-screen display 116 may automatically detect the static surface features on the skin, and transmit a corresponding signal to processor 110.

The process continues when processor 110 receives a signal associated with at least one static surface feature from a data store 306. In some embodiments, the data store may be a local data store associated with memory 112. In other embodiments, the data store may be a remote data store that is accessed via network interface 114. In such an embodiment, the processor 110 transmits a signal associated with the unique identifier to the remote data store via network interface 114. Then, the remote data store transmits a signal associated with the static surface features back to network interface 114. Network interface 114 transmits the signal to processor 110.

Next, processor 110 transmits a display signal to touch-screen display 116, 308. The display signal corresponds to a graphical user interface. In some embodiments, the processor 110 may generate the graphical user interface based at least in part on the unique identifier. In such an embodiment, processor 110 uses the signal received from a data store to determine information about the static surface features. Processor 110 uses this information to determine what image to display. For example, processor 110 may access information on the location of static surface features on touch-screen 116. Based on this information, processor 110 may determine a display signal which will generate an image only on sections of touch-screen display 116 which do not comprise static surface features.

In other embodiments, processor 110 may determine a display signal based at least in part on information input by the user about the static surface feature. For example, a user may place skin comprising a static surface feature on the touch-screen display 116. The user may then download a file comprising information about the location of the static surface feature to a data store on the mobile device. The mobile device may then use this file to determine the characteristics of the display signal. For example, the user may apply a skin over the surface of touch-screen display 116 comprising static surface features in the form of stereo controls. The user may then download a file comprising information about the locations of the static surface features. Processor 110 may use this information to determine a display signal, which places virtual stereo controls underneath corresponding static surface features. In other embodiments, the mobile device automatically detects the skin on the surface of the touch-screen display 116 and downloads a file corresponding to that skin to the mobile device's data store.

The process concludes by outputting an image associated with the display signal 310. In some embodiments, the image shown on the touch-screen display 116 may correspond to the static surface features. For example, in one embodiment, the static surface features may form a QWERTY keyboard. In this embodiment, at certain times the display may show a QWERTY keyboard that corresponds to the static surface features. In other embodiments, the display may show an image that does not correspond to the static surface features. For example, the display may show an image that the user has taken with the mobile device's camera function while the static surface features form a keyboard.

### Illustrative Scenarios for Using Static Surface Features on a Touch-Screen for Tactile Feedback

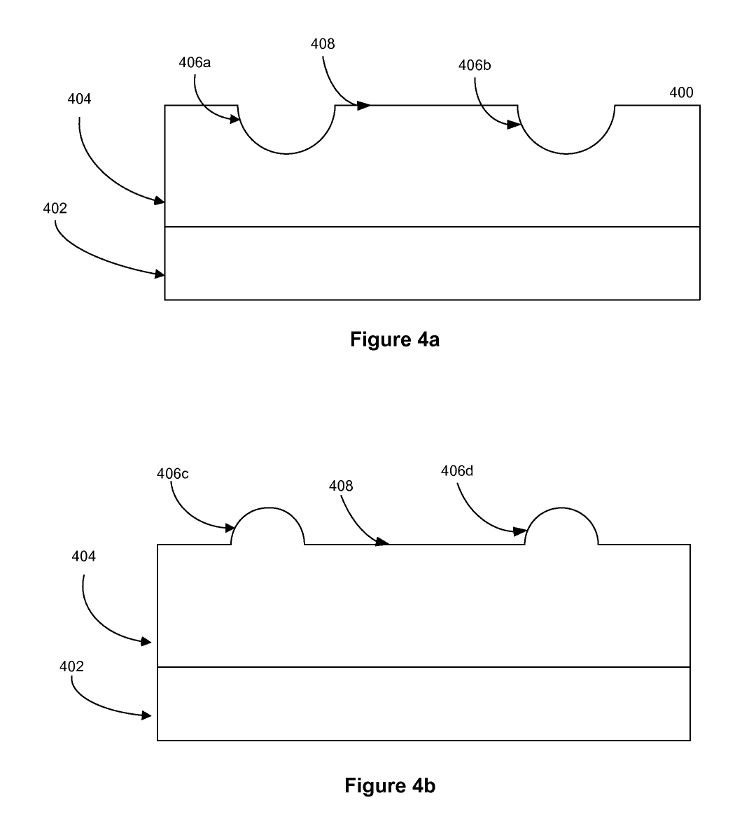

FIGS. 4a and 4b are cross-section illustrations of a system for using static surface features on a touch-screen for tactile feedback according to one embodiment of the present invention. The embodiments shown in FIGS. 4a and 4b comprise a cross section view of a mobile device 400. Mobile device 400 comprises an LCD display 402. Resting on top of the LCD display 402 is a touch-screen 404. In other embodiments, the LCD display 402 and touch-screen 404 may comprise a single integrated component, such as a touch-screen LCD display.

The touch-screen 404 comprises an ordinarily flat surface 408. Static surface features 406 cover at least a portion of touch-screen 404. In one embodiment shown in FIG. 4a, static surface features are formed by troughs 406a and 406b. In another embodiment shown in FIG. 4b, the static surface features are formed by ridges 406c and 406d. In other embodiments, the static surface features may include a combination of ridges and troughs (not shown). In still other embodiments, a curvature of the touch-screen itself may form the static surface features.

When the user drags a finger across touch-screen 408, the static surface features 406 provide the user with an indication of their finger's location. In some embodiments, the static surface features 406 may form letters or numbers. These letters or numbers may be arranged in a QWERTY keyboard configuration or in the configuration of a calculator. In other embodiments, the static surface features 406 may form a grid, web, or spiral configuration.

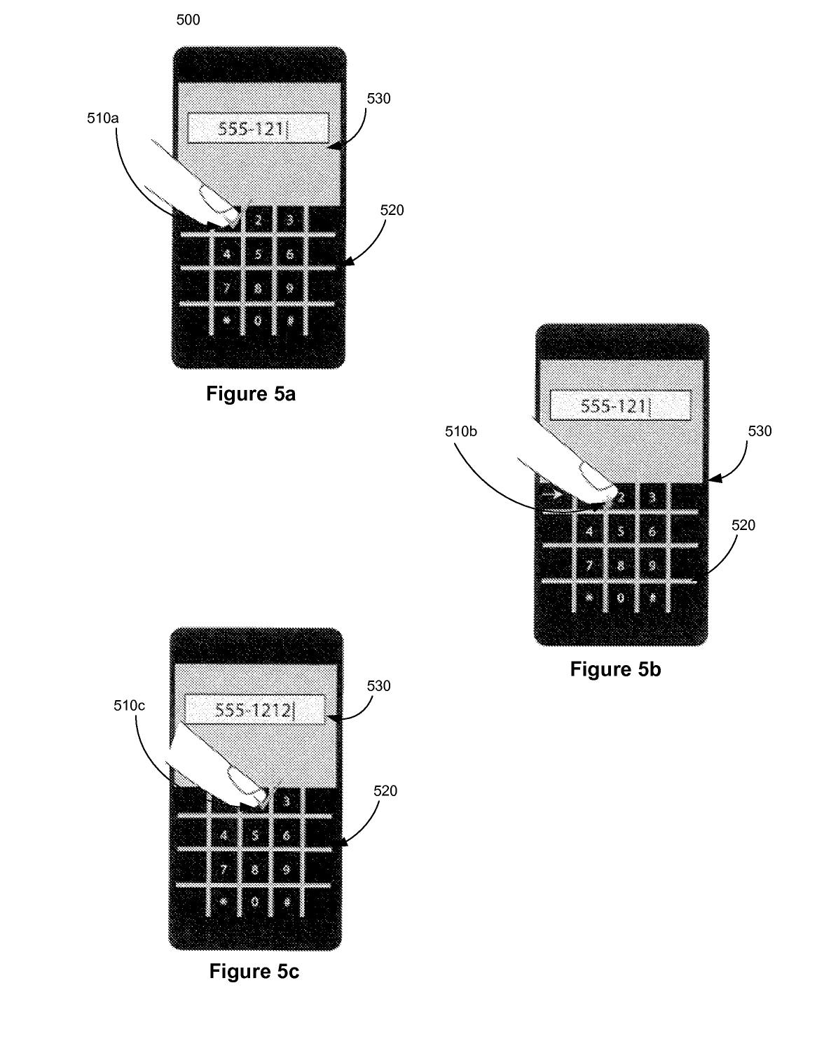

FIGS. 5a, 5b, and 5c are illustrations of a system for using static surface features on a touch-screen for tactile feedback according to one embodiment of the present invention. FIGS. 5a, 5b, and 5c show a mobile device 500. Mobile device 500 comprises a touch-screen display 530. Touch-screen display 530 comprises static surface features 520. In the embodiment shown, static surface features 520 form a grid and a numerical keypad. Arrows 510a, 510b, and 510c show a finger's movement across touch-screen display 530 and the impact of static surface features 520 on the finger's movement.

As shown in FIG. 5a the finger has just depressed the section of touch-screen display 530 associated with the number one 510a. In FIG. 5b, the user is attempting to drag their finger to the section of touch-screen display 530 associated with the number two. As shown by 510b, the grid formed by static surface features 520 indicates to the user that their finger is still on the section of the touch-screen display 530 associated with the number one. Then, in FIG. 5c, the user moved their finger off the static surface feature forming a grid, and onto the section of the touch-screen display 530 associated with the number two. As shown by arrow 510c, once in the appropriate section, the static surface feature forming the number two provides static feedback to the user, indicating that their finger is in the appropriate location.

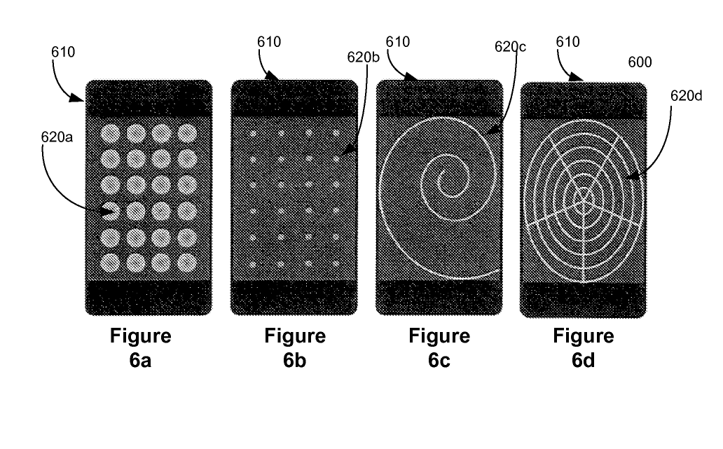

FIGS. 6a, 6b, 6c, and 6d are illustrations of a system for using static surface features on a touch-screen for tactile feedback according to one embodiment of the present invention. FIGS. 6a, 6b, 6c, and 6d each show a mobile device 600 comprising a touch-screen display 610. In each of the four figures, the touch-screen display 610 comprises a different skin. This skin comprises a static surface feature formed by raising or lowering at least a portion of the surface of the skin. These raised or lowered portions form ridges, troughs, or curvatures, which a user can feel when interacting with the touch-screen display. Each embodiment shows different examples of combinations of shapes, which may be formed using static surface features.

FIG. 6a shows one embodiment of a mobile device with a touch-screen 610 covered by a skin. In the embodiment shown, the skin comprises static surface features in the form of an array of large balls 620a. FIG. 6b shows the same mobile device in another embodiment where the skin comprises static surface features in the form of an array of small balls. FIG. 6c shows another embodiment wherein the skin comprises static surface features in the form of a swirling pattern. And FIG. 6d shows another embodiment wherein the skin comprises a static surface feature in the form of a web.

Each of the static surface features shown in FIGS. 6a, 6b, 6c, and 6d may be formed by applying a skin comprising a static surface feature to the touch-screen display 610. In other embodiments, the static surface feature may be formed by permanently modifying the surface of the touch-screen display 610. In some embodiments, the user may remove the skin, and replace it with a new skin comprising different static surface features. In such an embodiment, the user may change the static surface features on the touch-screen display 610. Thus, the user may apply different static surface features for different operations of the mobile device. In embodiments where the user applies different skins comprising different static surface features, the user may update a data store in the device, which comprises information about the static surface features. Processor 110 may use this data to determine the appropriate display signal to output to the touch-screen display 610.

In one embodiment, the user may update the data store manually by entering information via one of the mobile device's inputs. In other embodiments, the user may use the mobile device's network interface to download information about the static surface features. In still other embodiments, the mobile device may comprise a sensor, which detects when the user applies a different skin to the surface of the touch-screen display 610. For example, the skins shown in FIGS. 6a, 6b, 6c, and 6d may each comprise a unique identifier. When that skin is placed over the surface of touch-screen display 610, a sensor detects the unique identifier, and sends a signal corresponding to that unique identifier to the processor 110. The processor 110 may then access the data store to determine the appropriate action to take when that skin is detected.

For example, when the processor 110 receives an indication that the user placed a skin comprising static surface features in the form of large balls 620a over the surface of the touch-screen 610, the processor 110 will determine that a corresponding graphical user interface should be displayed. This embodiment enables a user to have multiple skins comprising different static surface features, for use with different applications. For example, in one embodiment a user may apply a skin comprising static surface features that form a QWERTY keyboard, for use when the user wishes to enter a text message. In another embodiment, the user may apply a skin comprising static surface features in the form of stereo controls for use with an application wherein the mobile device is a music player. In another embodiment, the user may apply a skin comprising static surface features in the form of numbers and mathematical symbols for use with a calculator application.

These embodiments are intended as examples, and are not meant to limit the endless possibilities of shapes that may be formed by placing a static surface feature on a touch-screen display.

### Advantages of Using Static Surface Features on a Touch-Screen for Tactile Feedback

Embodiments of systems and methods for using static surface features on a touch-screen for tactile feedback may provide various advantages over current user feedback systems. Systems and methods for using static surface features on a touch-screen for tactile feedback may leverage a user's normal tactile experiences and sensorimotor skills for navigating a graphical user interface. By leveraging a user's everyday tactile experiences and physical intuition, systems and methods for using static surface features on a touch-screen for tactile feedback may reduce a user's learning curve for a new user interface. Static surface features enable users to interact with the device without focusing all of their attention on the device. Thus, static surface features may increase the device's adoption rate and increase user satisfaction. Finally, static surface features on a touch-screen may allow a person with impaired eyesight to use a mobile device.

### GENERAL

The foregoing description of the embodiments, including preferred embodiments of the invention, has been presented only for the purpose of illustration and description. It is not intended to be exhaustive or to limit the invention to the precise forms disclosed. Numerous modifications and adaptations thereof will be apparent to those skilled in the art without departing from the spirit and scope of the invention.

That which is claimed is:

1. A system comprising:
a processor configured to transmit a display signal comprising a plurality of display elements; and
a display configured to output a visual representation of the display signal, the display comprising:
a touch-sensitive input device; and
one or more static surface features covering at least a portion of the display.

2. The system of claim 1, wherein the display comprises a touch-screen display.

3. The system of claim 1, wherein the one or more static surface features comprise: a trough, a ridge, or a curvature.

4. The system of claim 1, wherein the one or more static surface features form: letters or numbers.

5. The system of claim 1, wherein the one or more static surface features form a grid.

6. The system of claim 1, wherein the one or more static surface features correspond to the visual representation of the display signal.

7. The system of claim 1, wherein the one or more static surface features are created by placing a skin over the surface of the display.

8. The system of claim 7, wherein the skin comprises a unique identifier.

9. The system of claim 8, further comprising a sensor capable of detecting the unique identifier.

10. The system of claim 1, wherein the one or more static surface features correspond to the image shown on the display.

11. A method comprising:
receiving an indication that a skin comprising at least one static surface feature has been placed over the surface of a touch-screen display;
receiving a signal corresponding to a unique identifier associated with the skin;
transmitting a display signal to the touch-screen display; and
outputting an image associated with the display signal.

12. The method of claim 11, wherein the signal corresponding to the unique identifier is transmitted by the touch-screen display.

13. The method of claim 11, wherein the signal corresponding to the unique identifier is transmitted by a sensor.

14. The method of claim 12, wherein the unique identifier is one or more of: a bar code, an RFID, or a magnetic identifier.

15. The method of claim 11, wherein the at least one static surface feature comprises: a trough, a ridge, or a curvature.

16. The method of claim 11, wherein the at least one static surface feature forms: a letter or a number.

17. The method of claim 11, wherein the image is associated with the at least one static surface feature.

18. The method of claim 11, further comprising receiving a signal associated with the at least one static surface feature from a data store.

19. The method of claim 18, wherein the data store is a remote data store accessed via a network interface.

20. A mobile device, comprising:
a processor;
a touch-sensitive display in communication with the processor and configured to receive a display signal from the processor, the touch-sensitive display further configured to transmit input signals to the processor, the touch-sensitive display comprising:
at least one static surface feature covering at least a portion of the touch-sensitive display; and
a data store comprising data associated with the at least one static surface feature.
